(19) United States
(12) Patent Application Publication
(10) Pub. No.: US 2022/0349721 A1
(43) Pub. Date: Nov. 3, 2022

(54) DETERMINATION OF PATH TO VEHICLE STOP LOCATION IN A CLUTTERED ENVIRONMENT

(71) Applicant: Argo AI, LLC, Pittsburgh, PA (US)

(72) Inventors: Ramadev Burigsay Hukkeri, Pittsburgh, PA (US); Jay Sidhu, Federal Way, WA (US); Mauro Della Penna, San Francisco, CA (US); Jonathan Pan, Campbell, CA (US)

(21) Appl. No.: 17/244,420

(22) Filed: Apr. 29, 2021

(51) Int. Cl. G01C 21/34

(52) U.S. Cl. CPC G01C 21/3438; G01C 21/3453; G01C 21/3415; G01C 21/3446

(57) ABSTRACT

Methods and systems for enabling an autonomous vehicle (AV) to determine a path to a stopping location are disclosed. Upon receipt of a service request, the AV will determine a desired stop location (DSL) and state information for the service request. The AV using the DSL and the state information to define a pickup/drop-off interval that comprises an area of a road that includes the DSL. When approaching the pickup/drop-off interval, the AV will uses its perception system to determine whether an object is occluding the DSL. If no object is occluding the DSL, the AV will continue along the path toward the DSL. However, if an object is occluding the DSL, the AV will identify and move to a non-occluded alternate stop location (ASL) within the pickup/drop-off interval. The ASL must satisfy one or more permissible stopping location criteria.

### BACKGROUND

An autonomous vehicle (AV) can be used as a taxi, ride-sharing service, shuttle or similar vehicle that will pick up and/or drop off a passenger or package. When an AV performs a pickup or drop-off operation at a location that does not have a designated parking area (such as in front of a hotel or other building on a city street), the AV's navigation system must determine a location along a road where the pickup or drop-off will occur. In some such situations, the package or passenger is not ready and the AV must pull over to wait until the passenger or package is ready for pickup. In other situations, the AV may need to pull over to allow another vehicle to pass while the AV waits. Other pickup/drop-off locations may not have parking areas but instead require a stop in a designated lane, such as a taxi queue lane or a driveway in front of a hotel entrance.

When this happens, the AV must intelligently select a stop and/or pullover location. In some situations, it may be acceptable for the AV to stop in its lane of travel and even double-park for a brief time period. In other situations, the vehicle may need to pull over to a curbside or other location to avoid traffic while performing a longer pickup or a hold-in-place operation. This is a computationally challenging problem, especially in cluttered urban environments where available space to stop may be limited and numerous other actors must be considered before the vehicle implements any maneuver.

This document describes methods and systems that are directed to addressing the problems described above, and/or other issues.

### SUMMARY

This document describes methods and systems for enabling an autonomous vehicle (AV) to determine a path to a stopping location. The AV will include a perception system that has various sensors, a motion control system, and a motion planning system. The AV will determine a desired stop location (DSL) and state information that is associated with a service request. The AV will use the DSL and the state information to define a pickup/drop-off interval that comprises an area of a road that includes the DSL. The AV will identify a path to the DSL, in which the path traverses at least part of the pickup/drop-off interval. The AV will cause the motion control system to move the vehicle along the path toward the pickup/drop-off interval. Upon approaching or reaching the pickup/drop-off interval, the AV will use one or more sensors of the perception system to determine whether an object is occluding the DSL. If no object is occluding the DSL, the AV will cause the motion control system to move the vehicle along the path toward the DSL. However, if an object is occluding the DSL, the AV will identify an alternate stop location (ASL). The ASL will be a location within the pickup/drop-off interval that is not occluded and that satisfies one or more permissible stopping location criteria. The AV's motion control system will then move the vehicle toward the ASL.

In some embodiments, to identify the ASL within the pickup/drop-off interval the AV will first identify multiple candidate ASLs. For each of the candidate ASLs, the AV determine a cost to the vehicle for stopping at the ASL. The AV will then select, from the candidate ASLs, an ASL having the lowest determined cost. To determine the cost to the vehicle for stopping at the ASL, the AV may determine a distance between the ASL and the DSL assign a cost factor that increases with distance from the DSL, and determine the cost as a function of the cost factor. In addition or alternatively, to determine the cost to the vehicle for stopping at the ASL the AV may, for each of the candidate ASLs: determine a distance between the ASL and a starting position of the pickup/drop-off interval, assign a cost factor that increases with distance from the starting position, and determine the cost as a function of the cost factor. In addition or alternatively, to determine the cost to the vehicle for stopping at the ASL the AV may, for each of the candidate ASLs: use the perception system to identify objects in the pickup/drop-off interval; identify a gap between each successive pair of objects in the pickup/drop-off interval; for each ASL that is positioned in one of the gaps, determine a cost factor as a function of size of the gap, wherein the cost factor decreases with size of the gap; and determine the cost as a function of the cost factor.

In some embodiments, to define the pickup/drop-off interval, when the service request includes a request to either (i) receive a package that exceeds a threshold weight or (ii) pick up a passenger with limited mobility, the AV may require that the ASL not extend beyond a threshold distance from the DSL.

In some embodiments, before moving into the DSL or the ASL, the AV may determine whether moving to the DSL or the ASL would impose greater than a threshold cost on another actor that is proximate to the vehicle. If moving to the DSL or the ASL would impose greater than the threshold cost on the other actor, the system may select a different ASL in the pickup/drop-off interval that will not impose greater than the threshold cost on the other actor. The system may then cause the motion control system to move the vehicle into the different ASL.

In some embodiments, before moving into the DSL or the ASL, if the AV determines that an obstacle that was not previously present has entered the DSL or the ASL, the AV may select a different ASL in the pickup/drop-off interval that does not include an obstacle. The AV may then move into the different ASL.

### BRIEF DESCRIPTION OF THE DRAWINGS

FIG. 1 illustrates example components of system in which an autonomous vehicle (AV) receives a ride service request from an electronic device.

FIG. 2 illustrates a pickup/drop-off interval of a mapped area within which an AV may perform a pickup or drop-off service at or near a desired stopping location.

FIG. 3 is a flow diagram illustrating example steps by which an AV may determine a final stopping location for a pickup or drop-off service request.

FIG. 4 is flowchart illustrating a process for using user preference data to determine a loading point for a ride service.

FIGS. 5A-5E illustrate example cost functions for selecting loading point stopping locations for a ride service.

FIG. 6 is a block diagram that shows a high-level overview of certain AV subsystems.

FIG. 7 illustrates example systems and components of an autonomous vehicle.

FIG. 8 is a block diagram that illustrates various elements of a possible electronic subsystem of an AV and/or external electronic device.

### DETAILED DESCRIPTION

As used in this document, the singular forms “a,” “an,” and “the” include plural references unless the context clearly dictates otherwise. Unless defined otherwise, all technical and scientific terms used herein have the same meanings as commonly understood by one of ordinary skill in the art. As used in this document, the term “comprising” (or “comprises”) means “including (or “includes”), but not limited to.” Definitions for additional terms that are relevant to this document are included at the end of this Detailed Description.

This document describes processes by which an autonomous vehicle (AV) may make decisions about where and when to move when making a ride service trip during which the AV will pick up, drop off, or both pick up and drop off one or more passengers (which may be people or objects such as packages). A ride service may include any or all of the following elements: (1) navigating to a pickup location, and in particular a location at which the AV can stop to allow the passenger to get into the vehicle in compliance with permissible stopping criteria; (2) picking up the passenger by stopping for sufficient time for the passenger to board, and (optionally) time to complete one or more other pickup tasks; (3) navigating to a drop-off location, and in particular a location at which the AV can stop to allow the passenger to disembark in compliance with permissible stopping criteria; and (4) dropping off the passenger by stopping for sufficient time for the passenger to exit the vehicle, and (optionally) time to complete one or more other drop-off tasks. Elements (1) and (2) may be skipped if the vehicle is starting at a fixed point of origin such as a loading terminal, parking lot, or other predetermined location that is not dynamically determined.

When navigating in an environment, AVs rely on high definition (HD) maps. An HD map is a set of digital files containing data about physical details of a geographic area such as roads, lanes within roads, traffic signals and signs, barriers, and road surface markings. An AV uses HD map data to augment the information that the AV's on-board cameras, LiDAR system and/or other sensors perceive. The AV's on-board processing systems can quickly search map data to identify features of the AV's environment and/or to help verify information that the AV's sensors perceive.

Some pickup and drop-off locations may be predefined and stored in the available HD map. Such locations may include, for example: hotel driveways; airports; other locations with taxi, rideshare and/or shuttle stops; and other venues that have defined passenger pickup and/or drop-off locations. In such locations, the AV must be able to navigate to the predefined location but make adjustments if the passenger is not present at the location, or if obstacles prevent the AV from reaching the predefined location. In other areas such as urban environments, the pickup or drop-off location may not be fixed. For non-fixed locations, in each case the AV must dynamically determine when and where it can execute pickup and drop-off operations in compliance with permissible stopping criteria. The AV must be able to make these decisions in consideration of the criteria, passenger convenience and the burden that the AV's stop may place on other vehicles that are moving near the pickup/drop-off location.

To address this, the processes described in this document will consider the concepts of “Desired Stopping Locations” (DSLs), “Alternate Stopping Locations” (ASLs), “Final Stopping Location” (FSL), “Pickup/Drop-off Intervals” (PDIs) and “Pickup/Drop-off Queues” (PDQs).

As used in this document, a Desired Stopping Location (DSL) is a location for which a passenger submits a request for a pickup or drop-off operation. In other words, it the location at which the passenger asks to board or exit the AV. This document also may use the term “loading point” as a synonym for a DSL.

An Alternate Stopping Location (ASL) is an area that is suitable for an AV to perform a pickup or drop-off operation when the DSL cannot be served.

A Final Stopping Location (FSL) is the location at which the AV actually stops to perform the pickup or drop-off operation. The FSL may be the DSL, the ASL, or another location.

A Pickup/Drop-off Interval (PDI) is a zone around a stopping location (DSL, ASL or FSL) at which an AV is permitted to stop for a pickup or drop-off operation, in which the permission is defined by a stored set of rules. PDIs are used as a guide to help a vehicle dynamically determine where to stop, such as in-lane or curbside.

A Pickup/Drop-off Queue (PDQ) is a sector of a mapped area within which an AV is permitted to stop for a pickup or drop-off operation, in which the permission is defined by a polygon that includes the DSL, ASL or FSL. The polygon will be denoted in HD map data that is available to the AV. In contrast to PDIs, which are dynamically determined, PDQs are predefined.

Definitions for additional terms that are relevant to this document are included at the end of this Detailed Description.

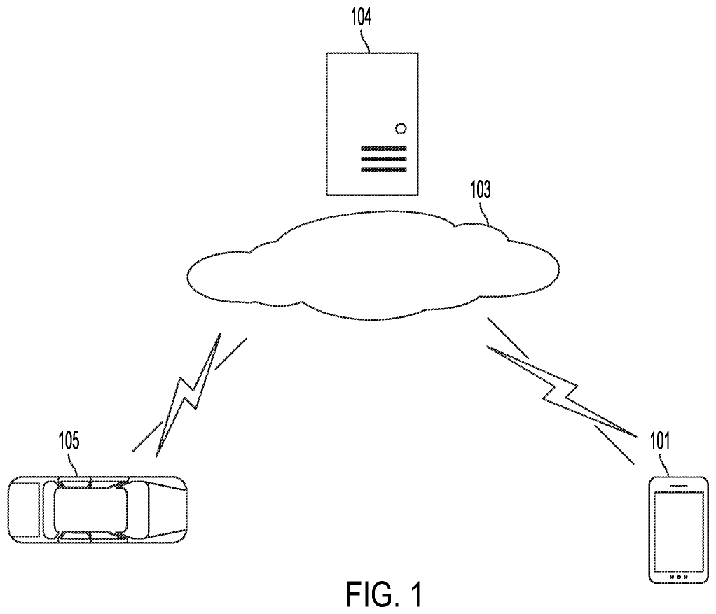

The processes described in this document start with transmission and receipt a ride service request, which is illustrated by way of example in FIG. 1, in which a transceiver of an AV 105 receives a ride service request that a passenger electronic device 101 transmitted via a wireless communication network 103. The request is shown as transmitted via a remote server 104 that receives the request, processes it, and relays it to the AV via the network 103. However, the ride service request could also be transmitted directly from the passenger electronic device 101 to the AV 105, such as by a Bluetooth or other near-field or short range communication, in which the request could be to initiate a new ride service request or alter an existing ride service request. In addition, a ride service request may be directly input into a user interface of the AV, such as an in-dashboard touch screen display device or a microphone that is part of a vehicle speech-to-text recognition system.

The passenger electronic device 101 is an electronic device containing a browser, a dedicated ride service application or another application via which a user of the device may submit a request for a vehicle ride by entering a starting point, a destination, or both. The request will be in the form of data, transmitted via data packets, that includes a loading point or PDI for a loading operation, a loading point or PDI for an unloading operation, and optionally other information such as identifying information about the passenger, as well as a pick-up time. The operator of the electronic device 101 may be the passenger who is requesting the ride, or someone else who is requesting the ride on behalf of the passenger. Further, in some embodiments the “passenger” need not be a person but could be a package, an animal, or another item for which the operator of the electronic device 101 submits a ride service request. In such situations the ride service request may actually be a delivery service request. For simplicity, except where specifically denoted when this document uses the term “ride service” it should be interpreted to include both passenger and package transportation services, and the term “passenger electronic device” should be interpreted to include devices operated by or on behalf of passengers as well as devices operated by individuals who seek delivery of a package.

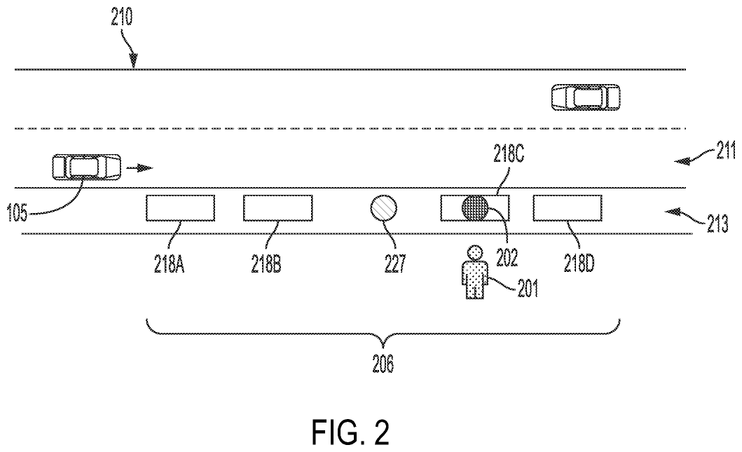

The concepts of a Pickup/Drop-off Interval, Desired Stopping Location, Alternate Stopping Locations and Final Stopping Location are now illustrated by way of example in FIG. 2, in which the AV 105 has access to a map of an area, which in this example is a grid of several blocks of city streets, including street 210. Street 210 includes multiple lanes, including the AV's lane of travel 211 and a curbside or parking lane 213. The map will typically be stored in a memory device onboard the vehicle, although it could also be stored on a mobile electronic device or offboard server that is in communication with the AV. The map may be periodically updated by the remote server and/or augmented by information that the AV's perception system detects as the AV 105 moves through the area.

The AV 105 receives a service request to pick up or drop off a passenger 201 or package at a DSL 202. The AV 105 then determines a path or route along which the AV 105 may navigate to the DSL 202. The path may be a sequence of streets or lanes leading up to a PDI 206, which in the example shown is a set of one or more lane segments that form a stopping interval of the parking lane 213 that includes the DSL 202, as well as a region of the parking lane 213 that the AV 105 can reach before the DSL 202 and a region of the parking lane 213 that the AV 105 can will reach after passing the DSL 202.

As shown in FIG. 2, any number of obstacles 218A-218D may be positioned in the PDI 206. The obstacles 218A-218D, which this document also may refer to alternatively as obstructions or occlusions, may be other vehicles, people, structures, signs or other items that prevent the AV from entering the PDI at the obstacle's location. In this example, one of the obstacles 218C prevents the AV from stopping at the DSL 202. The AV's perception system will identify and classify each of these obstacles, and since the DSL is blocked the AV's motion planning system will determine one or more regions within the PDI that can serve as an alternate stopping location. Ultimately, the AV's motion planning system will select one of the alternate stopping locations as the FSL 227 to which it will navigate and perform the pickup or drop-off operation. Methods by which the AV will determine the alternate stopping locations and the FSL 227 will be described below.

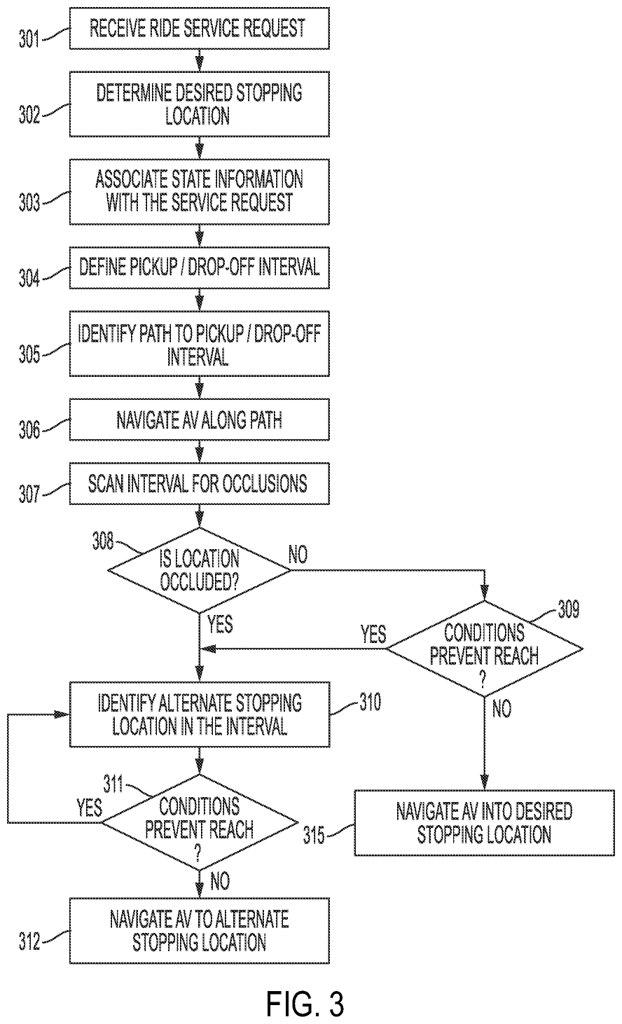

FIG. 3 is a flow diagram illustrating example steps by which an AV may determine an FSL for a pickup or drop-off service request. At 301 the AV will receive a ride service request that was transmitted to the AV by a ride service application on a passenger electronic device, either directly via a remote server that receives the request, processes it, selects the AV to handle the request, and transmits the request to the AV. The request will be in the form of data that includes a PDI or DSL for a loading operation, a PDI or DSL for an unloading operation, and optionally other information such as identifying information about the passenger, as well as a pick-up time.

At 302 the AV will determine a DSL for a loading or unloading operation of the ride service request. The DSL will be determined as a location on the map or a set of geographic coordinates that correlate to the map. The AV may receive the DSL as coordinates that are included in the service request. Alternatively, the AV or an intermediate server may use data from the service request to identify the DSL. For example, the ride service request may include an address, landmark or other location at which the passenger requests a loading operation. Such locations may include, for example, the entrance of a specified building, or a transit stop. The AV or intermediate offboard server may then determine the coordinates in the map data that correspond to the service request location, and it may designate those coordinates as the DSL.

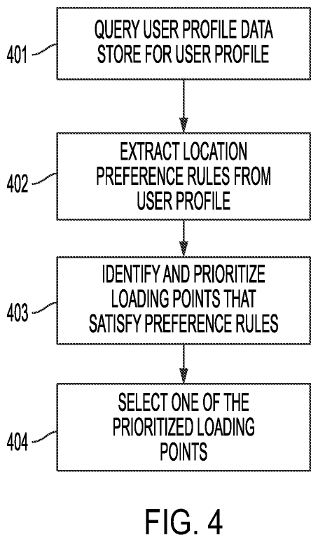

In addition or alternatively, as illustrated in FIG. 4 at 401 to determine the DSL the system may use a user identifier associated with the passenger electronic device to query a user profile data store to identify a stored profile that is associated with the same user identifier. The user profile data store may be part of a remote server such as server 105 of FIG. 1, stored in the AV's onboard memory, or a combination of the two. At 402 the system may extract, from the identified profile, one or more location preference rules for the user. At 403 the system will then analyze the map data and only consider a location to qualify to be a DSL if it satisfies at least a threshold number of the user's location preference rules. In addition, the system may rank, score and/or otherwise prioritize candidate loading points depending on how many of the location preference rules they satisfy, or by assigning each location a score that in which some location preference rules are given higher weights than others. For example, the rules may require that a DSL be positioned in a lane segment or group of lane segments that are located in front of an entry door of a building having a location that corresponds to a location of the electronic device, or the rules may assign a relatively higher weighted value to such lane segments in a scoring algorithm. Alternatively, the rules may require that any DSL be midway between or close to the cross street that is next in the direction of traffic while remaining at least six meters (or another suitable threshold distance) away from that cross street, or that is no longer than a specified walking distance from a designated point. The rules also may assign relatively higher weighted values to such lane segments in a scoring algorithm. In addition, if the user profile includes a stored DSL from a previous ride service, the rules may require that the system give first priority to and use the stored DSL as the loading point for the current ride sharing request. Optionally, the system may require that the DSL meet both user preference criteria and one or more rules such as those discussed below.

Returning to FIG. 3, at 303 the AV will associate state information with the service request. State information is one or more characteristics describing a state of the passenger or package, and/or one or more characteristics describing a state of the AV itself, that the AV's navigation system must consider when defining an FSL for the service request. Example state information can include:
A weight of a package that is to be picked up during a service request. A package weight that exceeds a threshold weight value may trigger a rule that the FSL must not exceed a threshold distance from the DSL.
An indicator that the passenger or package is not ready to be picked up. Such an indicator may trigger a rule that the AV must pull over to a curbside FSL and must not stop at an in-lane FSL.
An indicator that the passenger that is to be picked up has limited mobility. Such an indicator may trigger a rule that the FSL must not exceed a threshold distance from the DSL.
An indicator that one or more systems of the AV are signaling a maintenance issue, such as a low tire pressure signal or a check engine signal. Such an indicator may trigger a rule that the AV must pull over to the nearest permissible curbside FSL.

At 304 the system will define a PDI for the ride service request. The system may do this by any of a possible number of ways. For example, standard PDIs for various locations may be stored in the map data, and the system may extract from the map data a PDI that includes the loading point. Alternatively, a PDI may be a predetermined queue location (such as an airport or train station ride sharing queue area) that includes the loading point. Alternatively, the system may dynamically determine the PDI based on one or more rules, such as by starting with a threshold distance before and after the DSL, and then modifying the interval boundaries as required by one or more rules, such as:
rules triggered by the state information (such as those discussed above in the examples of step 303);
in-lane or curbside parking must be permitted by law in the lane segments of the PDI;
the speed limit associated with lane segments in the PDI must not be more than a specified threshold level (such as 30 miles per hour or 50 kilometers per hour);
the boundaries of the PDI must not be located less than a specified distance (such as 6 meters) from an intersection;
the PDI must not include a crosswalk;
the PDI must be adjacent to a curb of the street of which it is a part;
the PDI must not be adjacent to an exit ramp of a parking garage; or
the PDI must not include an area that is designated in map data as a no-stop zone.

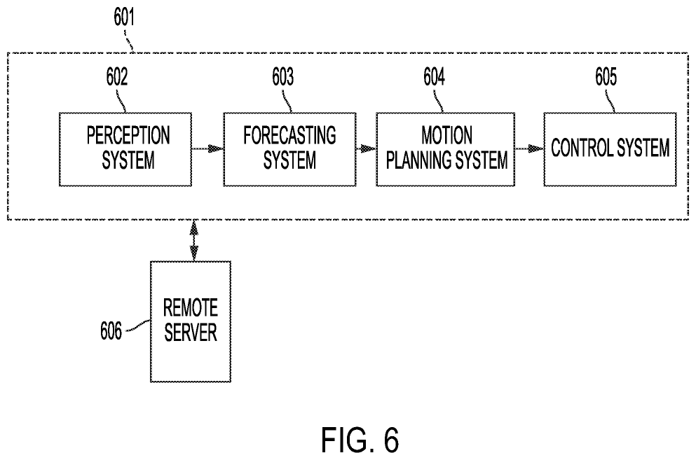

At 305 the AV will identify a path to the DSL that passes along at least part of the PDI. The AV may do this using any now or hereafter trajectory generation processes. For example the system may receive the path from an external server, or it may use the HD map data to generate a path comprising a set of contiguous lane segments between the AV's current location and the DSL. Other trajectory planning methods will be discussed below in the context of FIG. 6. At 306 the vehicle's motion control subsystem will cause the AV to move along the path toward the DSL, using processes such as those described below in the context of FIG. 6. While moving along the path, the AV's motion planning system may dynamically alter the AV's path as the AV moves toward the DSL to avoid conflict with other actors and objects as it moves, using any now or hereafter known path planning processes.

At 307 when the vehicle reaches or approaches the PDI, the vehicle's cameras, LiDAR system, or other perception system sensors will scan the PDI to determine whether any objects occlude the DSL. For example, as was shown in FIG. 2, a vehicle 218C may be parked in the DSL 202 and thus prevent the AV from moving into the DSL. Other objects may occlude the DSL in whole or in part. For example, the perception system may determine that:
vehicles or other objects are positioned in front of and behind the DSL in locations that do not provide the DSL with sufficient space to move into the DSL;
the DSL contains a pothole of at least a threshold size, or a puddle of water;
the curb adjacent to the DSL includes a fire hydrant, mailbox, signpost or other object positioned in a location that will interfere with swinging the door of the AV open at the DSL; or
another object interferes with the AV's ability to enter into the DSL and/or perform a loading or unloading operation at the DSL.

If no occlusion prevents the AV from stopping in the DSL (308:NO), then the AV's motion control system may cause the AV to continue moving along the path into the DSL, and to stop at the DSL. However, if an occlusion will prevent the AV from stopping in the DSL (308:YES), then at 310 the AV's motion planning system may use perception data about the PDI to identify one or more alternate stopping locations within the PDI. To qualify as an ASL the location that is free from occlusion that will prevent the AV from stopping there. Optionally, each ASL also must satisfy one or more permissible stopping location criteria, such as:

Distance from curb: If stopping in a parking lane, the ASL must be within a threshold distance from the curb; if stopping in a lane of travel, the ASL must be biased to the right of the lane, optionally partially extending to an area that is outside of the lane.

Remaining lane width: In addition to or instead of distance from the curb, if the AV will stop fully or partially in a lane of travel it may consider the amount or size of the lane that will remain unblocked when it stops. If the AV will block too much of the lane, the AV may create a bottleneck for other vehicles that are trying to pass by the ASL. The system may give preference to ASLs that will allow for a relatively larger remaining lane width than it gives to those that require a relatively smaller remaining lane width, and thus help reduce the risk of causing bottlenecks.

Distance from DSL: The ASL may be required to be no more than a threshold distance from the DSL. The threshold may vary based on specified conditions. For example, if the service request includes a heavy package or a passenger with limited mobility, the threshold may be shorter than a default as described above. The threshold also may be reduced during certain environmental conditions, such as rain or snow.

Distance from start of the interval: ASLs that the AV reaches first may be given higher preference than ASLs that the AV will encounter later in the PDI. This helps to ensure that the AV finds a suitable stopping location before reaching the end of the PDI.

Gap between objects pairs adjacent to the DSL: An ASL of larger size (as defined by the locations of a pair of objects positioned in front of and behind the ASL) may be given preference to over an ASL that is of smaller size, especially if the smaller size will require the AV to angle into the ASL and remain partially protruding into the lane of travel.

Kinematic constraints of the vehicle: Steering limits of the vehicle's platform may limit the vehicle's ability to navigate into an ASL without exceeding a threshold number of multiple-point turns or forward/reverse gear changes. The system may give preference to those ASLs that do not require the thresholds to be exceeded, or which require relatively fewer multiple-point turns and/or forward/reverse gear changes.

Deceleration limits: An ASL that will require the AV to decelerate at a rate that his higher than a threshold in order to stop may be given less preference or avoided entirely. The system may determine the required deceleration by considering the distance D from the AV to the ASL and the vehicle's current speed V, using an equation such as deceleration=V²/2 D. The equation optionally also may factor in comfort parameters and other dynamic components of the vehicle's state.

Types and/or locations of objects or road features adjacent to the ASL: Some classes of objects (such as delivery trucks) are more likely to move or have people appear around them than other classes of objects (such as potholes or road signs). The system may give lower preference to ASLs that are adjacent to objects that are more likely to move. The system also may give lower preference to ASLs with (i) objects that are positioned in locations that would interfere with the opening of a curbside door of the AV, or (ii) certain features of the road at the ASL such as the presence of a driveway.

Alignment of the AV. The system may give preferences to ASLs in which the AV can position itself so that a side of the AV is relatively more parallel to the curb. This may mean giving preference to ASLs in which the curb is straight rather than curved, or ASLs that are shorter and cannot accommodate the full width of the AV.

The permissible stopping location criteria listed above are only examples. Any of these and/or other permissible stopping location criteria may be used.

When identifying the ASL in step 310, the system may identify more than one candidate ASL. If so, then it may use one of several possible methods to select the candidate ASL as the FSL into which the vehicle should move. For example, the system may select as the FSL the candidate ASL that meets the greatest number of the permissible stopping location criteria. Some of the permissible stopping location criteria may be designated as a gating criteria, such that a location will not even be considered to be an ASL if it does not meet the gating criteria. Other criteria may be used to rank candidate ASLs and select the ASL with the highest rank.

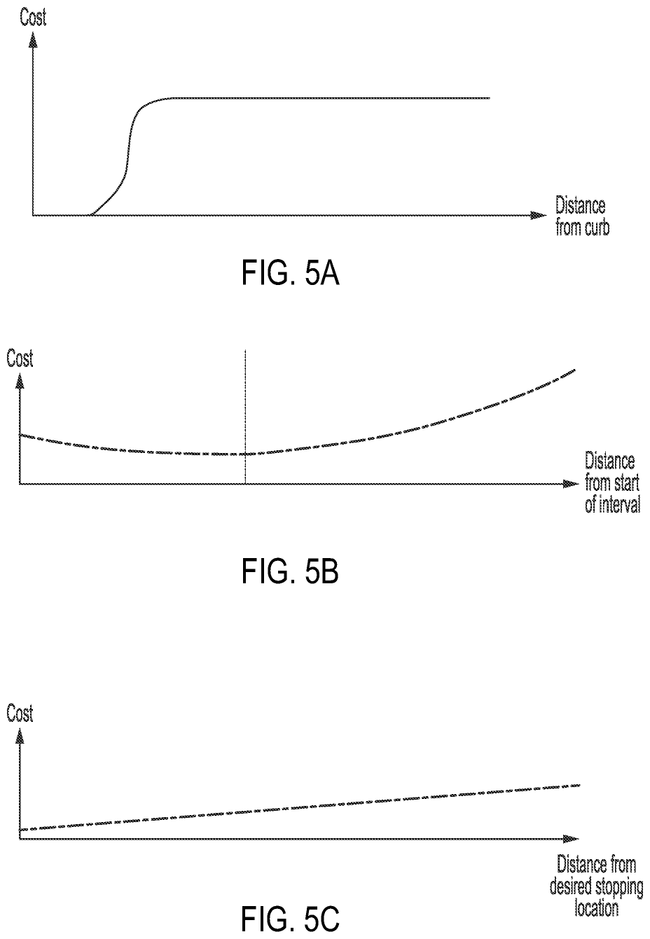

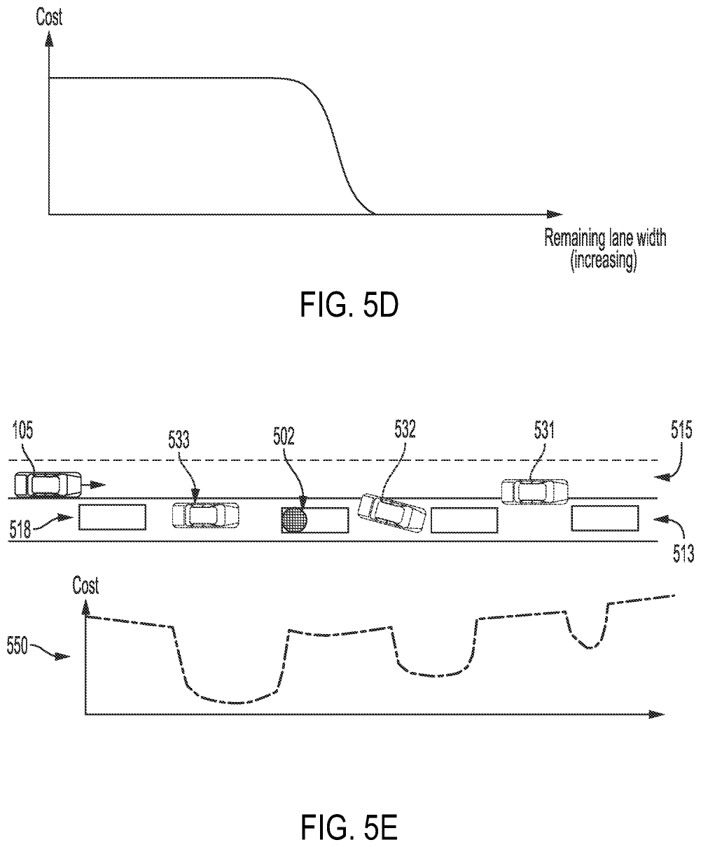

Any or all of the permissible stopping location criteria may be weighted or be associated with a cost element, such that a cost function sums or otherwise factors the cost elements for each criterion that is satisfied and yields an overall cost for each candidate ASL. For example, as illustrated in FIGS. 5A-5E, a cost function may sum various cost function elements of various candidate stopping locations. FIG. 5A illustrates an example cost function that assigns a lower cost value (and in some cases no cost) to stopping locations that are relatively closer to the curb, with higher cost values to stopping locations that are relatively further from the curb. FIG. 5B illustrates an example cost as a function of a stopping location's distance from the start of the PDI, with higher cost values to stopping locations that are relatively further from the PDI's starting point. FIG. 5C illustrates an example cost as a function of a stopping location's distance from the DSL, with higher cost values to stopping locations that are relatively further from the DSL. FIG. 5D illustrates an example cost function that assigns a lower cost value (and in some cases no cost) to stopping locations that are will allow relatively larger potions of a lane of travel to remain unobstructed.

Finally, FIG. 5E illustrates how the system may solve for a stopping location in a PDI that includes a parking lane 513 that has multiple obstructions (such as obstruction 518) in it. The cost function 550 sums all of the cost elements illustrated in FIGS. 5A-5D (and optionally other cost elements) to determine a candidate stopping location cost at various locations throughout the PDI. The DSL 502 is obstructed and therefore cannot be the final stopping location; the system must select an ASL. Locations at which obstructions 518 are located have the relatively higher cost. A first candidate ASL 531 in which the AV would block a significant portion of the lane of travel 515 and would be farthest from the DSL, farthest from the PDI's starting point and farthest from the curb is the candidate ASL with the highest cost. A second candidate ASL 532 in which the AV only partially extends into the lane of travel 515 and which is relatively closer to the curb, but which is past the DSL, is the candidate ASL with the second highest cost. A third candidate ASL 533 allows the AV to fully avoid the lane of travel 515 and get closest to the curb, and is closest to the DSl's point of origin has the lowest cost. The system therefore selects the third candidate ASL 533 and moves the AV 505 into that ASL 533.

Returning to FIG. 3, before moving the AV into a DSL or ASL, then in either step 309 or 311 the AV's motion planning system may determine whether environmental or traffic conditions near the DSL or ASL prevent the AV from reaching the ASL without taking an action that imposes greater than a threshold cost on other actors in the area. For example, if another vehicle is following the AV at a speed S and distance D within which it could not stop during an expected time T for the loading operation without hitting the AV (i.e., if D is less than or equal to S*T plus a buffer distance), or if the pickup/drop-off operation would require the other vehicle to decelerate by more than a threshold value, it may determine that the other vehicle will not be able to non-suddenly stop. The system may then not choose that stopping location and instead it may identify an ASL that does not cause the other vehicle to engage in such an action.

It is also notable that an AV's onboard systems will evaluate the environment in which the AV is traveling over multiple cycles, and continuously make adjustments. The AV's perception and motion planning systems may continuously monitor objects and environmental conditions to determine whether the selection of an ASL should be change. As other objects move in or out of the PDI, the changed conditions may prevent or hinder the AV from reaching the stopping location (as in steps 309 and 311 above). The AV will recalculate candidate ASLs and move to a different ASL if conditions warrant such a change.

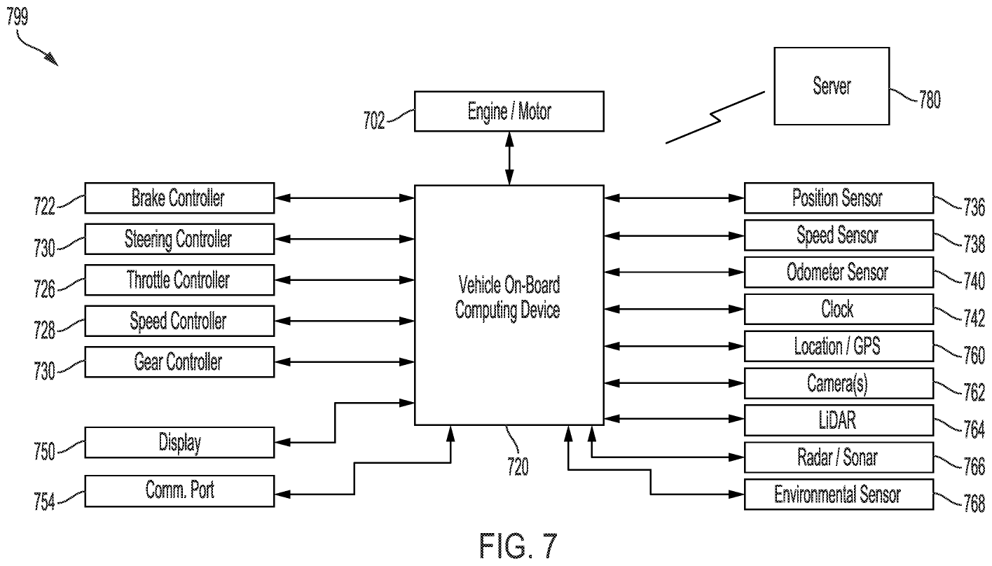

FIG. 6 shows a high-level overview of AV subsystems that may be relevant to the discussion above. Specific components within such systems will be described in the discussion of FIG. 7 later in this document. Certain components of the subsystems may be embodied in processor hardware and computer-readable programming instructions that are part of the AV's on-board computing system 601. The subsystems may include a perception system 602 that includes sensors that capture information about moving actors and other objects that exist in the vehicle's immediate surroundings. Example sensors include cameras, LiDAR sensors and radar sensors. The data captured by such sensors (such as digital image, LiDAR point cloud data, or radar data) is known as perception data.

The perception system may include one or more processors, and computer-readable memory with programming instructions and/or trained artificial intelligence models that, during a run of the AV, will process the perception data to identify objects and assign categorical labels and unique identifiers to each object detected in a scene. Categorical labels may include categories such as vehicle, bicyclist, pedestrian, building, and the like. Methods of identifying objects and assigning categorical labels to objects are well known in the art, and any suitable classification process may be used, such as those that make bounding box predictions for detected objects in a scene and use convolutional neural networks or other computer vision models. Some such processes are described in “Yurtsever et al., A Survey of Autonomous Driving: Common Practices and Emerging Technologies” (arXiv Apr. 2, 2020).

The vehicle's perception system 602 may deliver perception data to the vehicle's forecasting system 603. The forecasting system (which also may be referred to as a prediction system) will include processors and computer-readable programming instructions that are configured to process data received from the perception system and forecast actions of other actors that the perception system detects.

The vehicle's perception system, as well as the vehicle's forecasting system, will deliver data and information to the vehicle's motion planning system 604 and motion control system 605 so that the receiving systems may assess such data and initiate any number of reactive motions to such data. The motion planning system 604 and control system 605 include and/or share one or more processors and computer-readable programming instructions that are configured to process data received from the other systems, determine a trajectory for the vehicle, and output commands to vehicle hardware to move the vehicle according to the determined trajectory. Example actions that such commands may cause the vehicle hardware to take include causing the vehicle's brake control system to actuate, causing the vehicle's acceleration control subsystem to increase speed of the vehicle, or causing the vehicle's steering control subsystem to turn the vehicle. Various motion planning techniques are well known, for example as described in Gonzalez et al., “A Review of Motion Planning Techniques for Automated Vehicles,” published in IEEE Transactions on Intelligent Transportation Systems, vol. 17, no. 4 (April 2016).

During deployment of the AV, the AV receives perception data from one or more sensors of the AV's perception system. The perception data may include data representative of one or more objects in the environment. The perception system will process the data to identify objects and assign categorical labels and unique identifiers to each object detected in a scene.

The vehicle's on-board computing system 601 will be in communication with a remote server 606. The remote server 606 is an external electronic device that is in communication with the AV's on-board computing system 601, either via a wireless connection while the vehicle is making a run, or via a wired or wireless connection while the vehicle is parked at a docking facility or service facility. The remote server 606 may receive data that the AV collected during its run, such as perception data and operational data. The remote server 606 also may transfer data to the AV such as software updates, high definition (HD) map updates, machine learning model updates and other information.

FIG. 7 illustrates an example system architecture 799 for a vehicle, such as an AV. The vehicle includes an engine or motor 702 and various sensors for measuring various parameters of the vehicle and/or its environment. Operational parameter sensors that are common to both types of vehicles include, for example: a position sensor 736 such as an accelerometer, gyroscope and/or inertial measurement unit; a speed sensor 738; and an odometer sensor 740. The vehicle also may have a clock 742 that the system uses to determine vehicle time during operation. The clock 742 may be encoded into the vehicle on-board computing device, it may be a separate device, or multiple clocks may be available.

The vehicle also will include various sensors that operate to gather information about the environment in which the vehicle is traveling. These sensors may include, for example: a location sensor 760 such as a global positioning system (GPS) device; object detection sensors such as one or more cameras 762; a LiDAR sensor system 764; and/or a radar and or and/or a sonar system 766. The sensors also may include environmental sensors 768 such as a precipitation sensor and/or ambient temperature sensor. The object detection sensors may enable the vehicle to detect moving actors and stationary objects that are within a given distance range of the vehicle 799 in any direction, while the environmental sensors collect data about environmental conditions within the vehicle's area of travel. The system will also include one or more cameras 762 for capturing images of the environment. Any or all of these sensors will capture sensor data that will enable one or more processors of the vehicle's on-board computing device 720 and/or external devices to execute programming instructions that enable the computing system to classify objects in the perception data, and all such sensors, processors and instructions may be considered to be the vehicle's perception system. The vehicle also may receive state information, descriptive information or other information about devices or objects in its environment from a communication device (such as a transceiver, a beacon and/or a smart phone) via one or more wireless communication links, such as those known as vehicle-to-vehicle, vehicle-to-object or other V2X communication links. The term “V2X” refers to a communication between a vehicle and any object that the vehicle may encounter or affect in its environment.

During a run of the vehicle, information is communicated from the sensors to an on-board computing device 720. The on-board computing device 720 analyzes the data captured by the perception system sensors and, acting as a motion planning system, executes instructions to determine a trajectory for the vehicle. The trajectory includes pose and time parameters, and the vehicle's on-board computing device will control operations of various vehicle components to move the vehicle along the trajectory. For example, the on-board computing device 720 may control braking via a brake controller 722; direction via a steering controller 724; speed and acceleration via a throttle controller 726 (in a gas-powered vehicle) or a motor speed controller 728 (such as a current level controller in an electric vehicle); a differential gear controller 730 (in vehicles with transmissions); and/or other controllers.

Geographic location information may be communicated from the location sensor 760 to the on-board computing device 720, which may then access a map of the environment that corresponds to the location information to determine known fixed features of the environment such as streets, buildings, stop signs and/or stop/go signals. Captured images from the cameras 762 and/or object detection information captured from sensors such as a LiDAR system 764 is communicated from those sensors) to the on-board computing device 720. The object detection information and/or captured images may be processed by the on-board computing device 720 to detect objects in proximity to the vehicle 700. In addition or alternatively, the AV may transmit any of the data to an external server 780 for processing. Any known or to be known technique for performing object detection based on sensor data and/or captured images can be used in the embodiments disclosed in this document.

In addition, the AV may include an onboard display device 750 that may generate and output interface on which sensor data, vehicle status information, or outputs generated by the processes described in this document are displayed to an occupant of the vehicle. The display device may include, or a separate device may be, an audio speaker that presents such information in audio format.

In the various embodiments discussed in this document, the description may state that the vehicle or on-board computing device of the vehicle may implement programming instructions that cause the on-board computing device of the vehicle to make decisions and use the decisions to control operations of one or more vehicle systems. However, the embodiments are not limited to this arrangement, as in various embodiments the analysis, decision making and or operational control may be handled in full or in part by other computing devices that are in electronic communication with the vehicle's on-board computing device. Examples of such other computing devices include an electronic device (such as a smartphone) associated with a person who is riding in the vehicle, as well as a remote server that is in electronic communication with the vehicle via a wireless communication network.

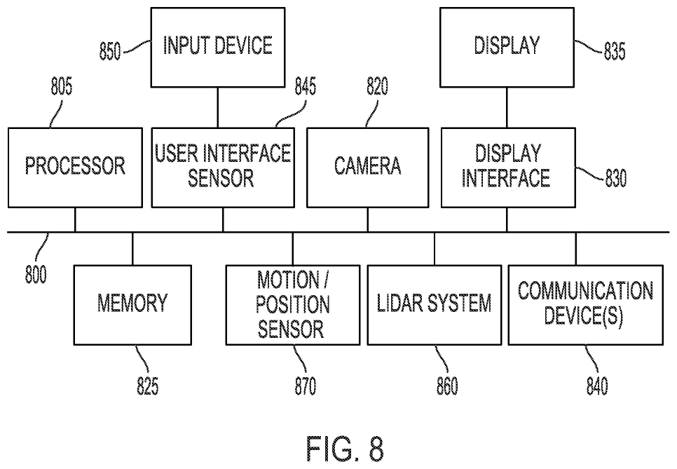

FIG. 8 depicts an example of internal hardware that may be included in any of the electronic components of the system, such as internal processing systems of the AV, external monitoring and reporting systems, or remote servers. An electrical bus 800 serves as an information highway interconnecting the other illustrated components of the hardware. Processor 805 is a central processing device of the system, configured to perform calculations and logic operations required to execute programming instructions that are stored on one or more memory devices 825. Various embodiments of the invention may include a computer-readable medium containing programming instructions that are configured to cause one or more processors to perform the functions described in the context of the previous figures.

An optional display interface 830 may permit information from the bus 800 to be displayed on a display device 835 in visual, graphic or alphanumeric format, such on an in-dashboard display system of the vehicle. An audio interface and audio output (such as a speaker) also may be provided. Communication with external devices may occur using various communication devices 840 such as a wireless antenna, a radio frequency identification (RFID) tag and/or short-range or near-field communication transceiver, each of which may optionally communicatively connect with other components of the device via one or more communication system. The communication device(s) 840 may be configured to be communicatively connected to a communications network, such as the Internet, a local area network or a cellular telephone data network.

The hardware may also include a user interface sensor 845 that allows for receipt of data from input devices 850 such as a keyboard or keypad, a joystick, a touchscreen, a touch pad, a remote control, a pointing device and/or microphone. Digital image frames also may be received from a camera 820 that can capture video and/or still images. The system also may receive data from a motion and/or position sensor 870 such as an accelerometer, gyroscope or inertial measurement unit. The system also may receive data from a LiDAR system 860 such as that described earlier in this document.

The features and functions disclosed above, as well as alternatives, may be combined into many other different systems or applications. Various components may be implemented in hardware or software or embedded software. Various presently unforeseen or unanticipated alternatives, modifications, variations or improvements may be made by those skilled in the art, each of which is also intended to be encompassed by the disclosed embodiments.

Terminology that is relevant to the disclosure provided above includes:

The term “vehicle” refers to any moving form of conveyance that is capable of carrying either one or more human occupants and/or cargo and is powered by any form of energy. The term “vehicle” includes, but is not limited to, cars, trucks, vans, trains, autonomous vehicles, aircraft, aerial drones and the like. An “autonomous vehicle” is a vehicle having a processor, programming instructions and drivetrain components that are controllable by the processor without requiring a human operator. An autonomous vehicle may be fully autonomous in that it does not require a human operator for most or all driving conditions and functions. Alternatively, it may be semi-autonomous in that a human operator may be required in certain conditions or for certain operations, or that a human operator may override the vehicle's autonomous system and may take control of the vehicle. Autonomous vehicles also include vehicles in which autonomous systems augment human operation of the vehicle, such as vehicles with driver-assisted steering, speed control, braking, parking and other advanced driver assistance systems.

The term “ride” refers to the act of operating a vehicle to move from a point of origin to a destination in the real world, while carrying a passenger or cargo that embarks or is loaded onto the vehicle at the point of origin, and which disembarks or is unloaded from the vehicle at the destination.

In this document, the terms “street,” “lane,” “road” and “intersection” are illustrated by way of example with vehicles traveling on one or more roads. However, the embodiments are intended to include lanes and intersections in other locations, such as parking areas. In addition, for autonomous vehicles that are designed to be used indoors (such as automated picking devices in warehouses), a street may be a corridor of the warehouse and a lane may be a portion of the corridor. If the autonomous vehicle is a drone or other aircraft, the term “street” or “road” may represent an airway and a lane may be a portion of the airway. If the autonomous vehicle is a watercraft, then the term “street” or “road” may represent a waterway and a lane may be a portion of the waterway.

An “electronic device”, “server” or “computing device” refers to a device that includes a processor and memory. Each device may have its own processor and/or memory, or the processor and/or memory may be shared with other devices as in a virtual machine or container arrangement. The memory will contain or receive programming instructions that, when executed by the processor, cause the electronic device to perform one or more operations according to the programming instructions.

The terms “memory,” “memory device,” “computer-readable medium,” “data store,” “data storage facility” and the like each refer to a non-transitory device on which computer-readable data, programming instructions or both are stored. A computer program product is a memory device with programming instructions stored on it. Except where specifically stated otherwise, the terms “memory,” “memory device,” “computer-readable medium,” “data store,” “data storage facility” and the like are intended to include single device embodiments, embodiments in which multiple memory devices together or collectively store a set of data or instructions, as well as individual sectors within such devices.

The terms “processor” and “processing device” refer to a hardware component of an electronic device that is configured to execute programming instructions, such as a microprocessor or other logical circuit. A processor and memory may be elements of a microcontroller, custom configurable integrated circuit, programmable system-on-a-chip, or other electronic device that can be programmed to perform various functions. Except where specifically stated otherwise, the singular term “processor” or “processing device” is intended to include both single-processing device embodiments and embodiments in which multiple processing devices together or collectively perform a process.

In this document, the terms “communication link” and “communication path” mean a wired or wireless path via which a first device sends communication signals to and/or receives communication signals from one or more other devices. Devices are “communicatively connected” if the devices are able to send and/or receive data via a communication link. “Electronic communication” refers to the transmission of data via one or more signals between two or more electronic devices, whether through a wired or wireless network, and whether directly or indirectly via one or more intermediary devices.

In this document, when relative terms of order such as “first” and “second” are used to modify a noun, such use is simply intended to distinguish one item from another, and is not intended to require a sequential order unless specifically stated.

1. A method of determining a path to a stopping location for an autonomous vehicle, the method comprising:
by a processor of an autonomous vehicle (AV), upon receipt of a service request:
determining a desired stop location (DSL) and state information that is associated with the service request;
using the DSL and the state information to define a pickup/drop-off interval that comprises an area of a road that includes the DSL;
identifying a path to the DSL, wherein the path traverses at least part of the pickup/drop-off interval;
causing a motion control system of the AV to move the AV along the path toward the pickup/drop-off interval;
upon approaching or reaching the pickup/drop-off interval, using one or more sensors of a perception system of the AV to determine whether an object is occluding the DSL; and
either:
upon determining that no object is occluding the DSL, causing the motion control system of the AV to move the AV along the path toward the DSL, or
upon determining that an object is occluding the DSL, identifying an alternate stop location (ASL) that is a location within the pickup/drop-off interval that is not occluded and which satisfies one or more permissible stopping location criteria, and causing the motion control system of the AV to move the AV toward the ASL.

2. The method of claim 1, wherein identifying the ASL within the pickup/drop-off interval comprises:
identifying a plurality of candidate ASLs;
for each of the candidate ASLs, determining a cost to the AV for stopping at the ASL; and
selecting, from the candidate ASLs, an ASL having the lowest determined cost.

3. The method of claim 2 wherein, for each of the candidate ASLs, determining the cost to the AV for stopping at the ASL comprises:
determining a distance between the ASL and the DSL;
assigning a cost factor to the distance, wherein the cost factor increases with distance from the DSL; and
determining the cost as a function of the cost factor.

4. The method of claim 2 wherein, for each of the candidate ASLs, determining the cost to the AV for stopping at the ASL comprises:
determining a distance between the ASL and a starting position of the pickup/drop-off interval;
assigning a cost factor to the distance, wherein the cost factor increases with distance from the starting position; and
determining the cost as a function of the cost factor.

5. The method of claim 2 wherein, for each of the candidate ASLs, determining the cost to the AV for stopping at the ASL comprises:
detecting, via the one or more sensors of the AV, a plurality of objects in the pickup/drop-off interval;
identifying a gap between each successive pair of objects in the pickup/drop-off interval;
for each ASL that is positioned in one of the gaps, determining a cost factor as a function of size of the gap, wherein the cost factor decreases with size of the gap; and
determining the cost as a function of the cost factor.

6. The method of claim 1, wherein using the DSL and the state information to define the pickup/drop-off interval comprises:
in response to the service request including receiving a package that exceeds a threshold weight or picking up a passenger with limited mobility, requiring that the ASL not extend beyond a threshold distance from the DSL.

7. The method of claim 1 further comprising, before causing the motion control system of the AV to move the AV into the DSL or the ASL:
determining whether moving to the DSL or the ASL would impose greater than a threshold cost on another actor that is proximate to the AV; and
in response to determining that moving to the DSL or the ASL would impose greater than the threshold cost on the other actor:
selecting a different ASL in the pickup/drop-off interval that will not impose greater than the threshold cost on the other actor, and
causing the motion control system of the AV to move the AV into the different ASL.

8. The method of claim 1 further comprising, before moving the AV into the DSL or ASL:
in response to determining that an obstacle that was not previously present has entered the DSL or the ASL:
selecting a different ASL in the pickup/drop-off interval that does not include an obstacle, and
causing the motion control system of the AV to move the AV into the different ASL.

9. A vehicle, comprising:
a perception system comprising a plurality of sensors;
a motion control system; and
a motion planning system comprising a processor and a memory containing programming instructions that are configured to cause the processor to:
determine a desired stop location (DSL) and state information that is associated with a service request,
use the DSL and the state information to define a pickup/drop-off interval that comprises an area of a road that includes the DSL,
identify a path to the DSL, wherein the path traverses at least part of the pickup/drop-off interval,
cause the motion control system to move the vehicle along the path toward the pickup/drop-off interval;
upon approaching or reaching the pickup/drop-off interval, use one or more sensors of the perception system to determine whether an object is occluding the DSL, and
either:
upon determining that no object is occluding the DSL, cause the motion control system to move the vehicle along the path toward the DSL; or
upon determining that an object is occluding the DSL, identify an alternate stop location (ASL) that is a location within the pickup/drop-off interval that is not occluded and which satisfies one or more permissible stopping location criteria, and cause the motion control system to move the vehicle toward the ASL.

10. The vehicle of claim 9, wherein the instructions to identify the ASL within the pickup/drop-off interval comprise instructions to:
identify a plurality of candidate ASLs;
for each of the candidate ASLs, determine a cost to the vehicle for stopping at the ASL; and
select, from the candidate ASLs, an ASL having the lowest determined cost.

11. The vehicle of claim 10, wherein the instructions to determine the cost to the vehicle for stopping at the ASL comprise instructions to, for each of the candidate ASLs:
determine a distance between the ASL and the DSL;
assign a cost factor to the distance, wherein the cost factor increases with distance from the DSL; and
determine the cost as a function of the cost factor.

12. The vehicle of claim 10 wherein the instructions to determine the cost to the vehicle for stopping at the ASL comprise instructions to, for each of the candidate ASLs:
determine a distance between the ASL and a starting position of the pickup/drop-off interval;
assign a cost factor to the distance, wherein the cost factor increases with distance from the starting position; and
determine the cost as a function of the cost factor.

13. The vehicle of claim 10 wherein the instructions to determine the cost to the vehicle for stopping at the ASL comprise instructions to, for each of the candidate ASLs:
detect, via the perception system, a plurality of objects in the pickup/drop-off interval;
identify a gap between each successive pair of objects in the pickup/drop-off interval;
for each ASL that is positioned in one of the gaps, determine a cost factor as a function of size of the gap, wherein the cost factor decreases with size of the gap; and
determine the cost as a function of the cost factor.

14. The vehicle of claim 10, wherein the instructions to use the DSL and the state information to define the pickup/drop-off interval comprise instructions to:
in response to the service request including receiving a package that exceeds a threshold weight or picking up a passenger with limited mobility, require that the ASL not extend beyond a threshold distance from the DSL.

15. The vehicle of claim 9 further comprising additional instructions to, before causing the motion control system to move the vehicle into the DSL or the ASL:
determine whether moving to the DSL or the ASL would impose greater than a threshold cost on another actor that is proximate to the vehicle; and
in response to determining that moving to the DSL or the ASL would impose greater than the threshold cost on the other actor:
select a different ASL in the pickup/drop-off interval that will not impose greater than the threshold cost on the other actor, and
cause the motion control system to move the vehicle into the different ASL.

16. The vehicle of claim 9 further comprising additional instructions to, before causing the motion control system to move the vehicle into the DSL or the ASL:
in response to determining that an obstacle that was not previously present has entered the DSL or the ASL:
select a different ASL in the pickup/drop-off interval that does not include an obstacle, and
cause the motion control system to move the vehicle into the different ASL.

17. A computer program product for determining a path to a stopping location for an autonomous vehicle (AV), the computer program product comprising instructions that are stored on a memory device and configured to cause an on-board processor of the AV to:
determine a desired stop location (DSL) and state information that is associated with a service request;
use the DSL and the state information to define a pickup/drop-off interval that comprises an area of a road that includes the DSL;
identify a path to the DSL, wherein the path traverses at least part of the pickup/drop-off interval;
cause a motion control system of the AV to move the AV along the path toward the pickup/drop-off interval;
upon approaching or reaching the pickup/drop-off interval, use a perception system of the vehicle to determine whether an object is occluding the DSL; and
either:
upon determining that no object is occluding the DSL, cause the motion control system to move the AV along the path toward the DSL, or
upon determining that an object is occluding the DSL, identify an alternate stop location (ASL) that is a location within the pickup/drop-off interval that is not occluded and which satisfies one or more permissible stopping location criteria, and cause the motion control system to move the AV toward the ASL.

18. The computer program product of claim 17, wherein the instructions to identify the ASL within the pickup/drop-off interval comprise instructions to:
identify a plurality of candidate ASLs;
for each of the candidate ASLs, determine a cost to the vehicle for stopping at the ASL by one or more of the following:
determining a distance between the ASL and the DSL, assigning a cost factor that increases with distance from the DSL, and determining the cost as a function of the cost factor,
determining a distance between the ASL and a starting position of the pickup/drop-off interval, assigning a cost factor that increases with distance from the starting position, and determining the cost as a function of the cost factor, or
detecting a plurality of objects in the pickup/drop-off interval, identifying a gap between each successive pair of objects in the pickup/drop-off interval, and for each ASL that is positioned in one of the gaps, determining a cost factor as a function of size of the gap, wherein the cost factor decreases with size of the gap; and
select, from the candidate ASLs, an ASL having the lowest determined cost.

19. The computer program product of claim 17, wherein the instructions to use the DSL and the state information to define the pickup/drop-off interval comprise instructions to:
in response to the service request including receiving a package that exceeds a threshold weight or picking up a passenger with limited mobility, require that the ASL not extend beyond a threshold distance from the DSL.

20. The computer program product of claim 17 further comprising additional instructions to, before causing the motion control system to move the AV into the DSL or the ASL:
determine whether moving to the DSL or the ASL would impose greater than a threshold cost on another actor that is proximate to the vehicle; and
in response to determining that moving to the DSL or the ASL would impose greater than the threshold cost on the other actor:
select a different ASL in the pickup/drop-off interval that will not impose greater than the threshold cost on the other actor, and
cause the motion control system to move the vehicle into the different ASL.

21. The computer program product of claim 17 further comprising additional instructions to, before causing the motion control system to move the vehicle into the DSL or the ASL:
in response to determining that an obstacle that was not previously present has entered the DSL or the ASL:
select a different ASL in the pickup/drop-off interval that does not include an obstacle, and
cause the motion control system to move the vehicle into the different ASL.
